(19) United States
(12) Patent Application Publication
(10) Pub. No.: US 2011/0093296 A1
(43) Pub. Date: Apr. 21, 2011

(54) Medical Identification Wristband

(76) Inventor: James Edward Klink, Ewa Beach, HI (US)

(21) Appl. No.: 12/906,974

(22) Filed: Oct. 18, 2010

Related U.S. Application Data
(60) Provisional application No. 61/252,684, filed on Oct. 18, 2009.

(51) Int. Cl. G06Q 50/00; G06F 13/38

(52) U.S. Cl. 705/3; 710/300

(57) ABSTRACT

Medical identification wristband that stores an individual's personal demographics; medical conditions; emergency contact information; all medications, dosages and times taken; medical/dental insurance information; advance directives and special treatment requests; X-rays and recent lab results; allergies; physicians and pharmacy addresses and phone numbers; past medical history including any diseases, surgeries, immunizations, etc.; I.D. Photo as well as an agenda to input medical appointments, notes and virtually any additional medical information. The medical information noted above will be stored in a stylish, electronic wristband that can be instantly seen on its small, graphic, LCD view screen 107 or uploaded to an ambulance or hospital computer via a USB cable connection. This data would include an entire medical history as well as any special treatment requests for chronic illness or advance directives; and allow patients to get in and out of the hospital faster, safer, and less expensively as well as lessen the number of lawsuits for mistreatment, thereby reducing physician malpractice premiums and the expenses insurance companies payout.

### CROSS REFERENCE TO RELATED APPLICATIONS:

This application claims priority from U.S. Patent Application Ser. No. 61/252,684, entitled “Medical Identification Wristband”, filed on 18 Oct. 2009. The benefit under 35 USC §119(e) of the United States provisional application is hereby claimed, and the aforementioned application is hereby incorporated herein by reference.

### TECHNICAL FIELD OF THE INVENTION

The present invention relates generally to identification wristbands and bracelets. More specifically, the present invention relates to identification wristband and bracelets that have the capacity to store complete medical information in a stylish, electronic wristband that can be instantly seen on a display screen.

### BACKGROUND OF THE INVENTION

Throughout time accurate patient identification has been a paramount concern in administering medication to, and performing medical procedures on, a patient. Years ago patient identification was relatively simple as local doctors would provide all types of medical care for essentially every person within a small community and knew each patient personally.

However, in today's medical environment, patient identification is a much more arduous task for many reasons. First, literally hundreds of patients are examined and treated on a daily basis in large modern medical facilities, each doctor or nurse interacting with as many as twenty or more patients within a single day. With such high traffic unaided positive patient identification is nearly impossible for any doctor or nurse.

Approximately 93% of people treated in the emergency room (ER) have no medical data or history available for doctors to peruse and the ER does not have a reliable system or means of accessing their records or data in an emergency. Chronically ill people (Diabetes, Heart Disease, Asthma, Seizure Disorders, etc) represent approximately 60% of all ER visits.

Second, many medical facilities are expansive including specialized departments which are spread out throughout the facility, many departments being on different floors or even in different buildings. For example, diagnostic examination, imaging, surgery, recovery, etc., areas are all usually separate and staffed by different personnel. As a patient is moved from one department to another, even if personnel within one department can visually identify a patient, personnel in another department may not be able to identify the patient.

Third, many patients are admitted into a medical facility for a period which is longer than a single shift. Where facility personnel changes during a patient's stay, unaided patient identification would be nearly impossible. Of particular note is that approximately ten percent of all admittances to hospitals fall into the category of chronically ill patients. These patients are a small percentage of those 68 million Americans who could benefit from wearing a medical alert wristband or carrying some information about their medical conditions. Only four percent of this group currently uses such a device. Unit sales of medical ID bracelets were 140,000 last year and are growing at an incredible rate of 28,000 annually. Because of the inexpensive cost of these proposed Medical Identification Wristbands, it is felt that at least 25% of this particular population or more will own one of these items within the next five years because of their functionality aspect and the invaluable peace-of-mind feeling they will instill.

Documented medical studies have proven that significant medical errors occur when the ER does not have access to a person's medical data, current medical tests and prescriptions. These studies indicate major opportunities for the present invention as the trend for emergency care is steadily increasing.

Fourth, in many cases medical personnel cannot rely on a patient for correct identification. Some patients might be unconscious, experiencing severe trauma, be under the influence of medication or be asleep, thereby making positive identification verification impossible. Approximately 93% of people treated in the ER have no medical data or history available for doctors to peruse and the ER does not have a reliable system or means of accessing their records or data in an emergency. Chronically ill people (Diabetes, Heart Disease, Asthma, Seizure Disorders, etc) represent approximately 60% of all ER visits.

Over 40 years ago, a physician concerned with his daughter's mistreatment in an emergency medical situation vowed to make changes to the health care system of that time that would better ensure proper emergency treatment for others. He went on to form the MedicAlert® Foundation Intl.; whereby, an emergency responder could make a call to a central database and receive a few lines of medical information about the person wearing a special MEDICALERT Bracelet or Pendant. At that time the new concept improved procedures but in today's market the system often leads to many more questions being posed by ER physicians regarding the general medical statements retrieved from the MEDICALERT database.

For years the standard for patient identification has been to place an identification bracelet on each patient's wrist. One great advantage of wearing a MEDICALERT type of Bracelet/Pendant is the fact that it is now a medical alerting device recognized by emergency responders and hospitals across the world. This is what EMT's and hospital personnel look for when a patient is brought into the E.R. As a symbolic, medical alerting device, it works. Other types of related devices including key-chain data drives, chip implants and smart cards requiring special readers or bulky PDA's hidden in a purse, back pocket, belt, etc. just haven't succeeded in formulating a following or health-related interest.

A user programmable message watch is known from U.S. Pat. No. 4,303,996, issued Dec. 1, 1981. The watch includes a light emitting diode (LED) display and is capable of displaying a pre-programmed message of up to five words one word at a time upon depression of a push button, according to the patent. It is also known from U.S. Pat. Nos. 3,805,427 (Apr. 23, 1974) and U.S. Pat. No. 3,864,856 25 (Feb. 11, 1975) to provide medical emergency data on a card held in a compartment of a watch, strap, or bracelet.

U.S. Pat. No. 5,877,742 (Mar. 2, 1999) teaches a more stylish, medical identification bracelet that has electronic circuitry to display detailed, patient medical information. The bracelet is formatted using a programming station (PC) into which is entered up to 16 k bits of medical & personal information about an individual. The programming station transfers the formatted information to the bracelet via an infrared interface device. The medical identification bracelet has an LCD view screen which displays, in a scrolling fashion, data when a button is pushed. The information may be scrolled in either direction and paused. All information is available at the display. The character size is selected to be visible to the unaided eye. The display is illuminated for low light reading.

U.S. Pat. No. 5,012,229 (Apr. 30, 1991) teaches a wearable personal/medical information device includes a data display with an associated legend display. A memory stores items of personal and/or medical information relating to the person wearing the device. Upon operation of a switch, the stored information is displayed with the personal/medical information indicated by the data display, and a corresponding legend indicated by the legend display. In a preferred embodiment, certain data such as medical information is preset in a read only memory, and other data, which the user may change from time-to-time, is stored in a read/write memory.

U.S. Pat. Pub. No. 2003/0016122 (Jul. 19, 2001) teaches an apparatus for identifying and providing information relating to a patient in a healthcare facility comprises a wristband worn by the patient and a radio frequency identification (RFID) transponder coupled to the wristband. The transponder is capable of automatically and periodically generating and transmitting a first signal encoding the identity and location of the patient to an RF receiver, and generating and transmitting a second signal encoding the identity and the medical records of the patient to an RFID reader in response to receiving an interrogation signal from the reader. The reader may be operatively coupled to a device for providing medical treatment or diagnosis.

It will be appreciated that the mentioned devices are not suitable for storing and displaying extensive personal and/or medical information data.

Also known is a so-called Med-Alert bracelet that has information engraved into the bracelet. Such information can be a combination of personal and medical data. The Med-Alert bracelet, as well as the watch straps or bracelets that hold emergency data cards, have the disadvantage that any change in the data necessitates a whole new bracelet or card.

The various features of novelty, which characterize the present invention are pointed out with particularity in the claims annexed to and forming a part of the present disclosure. For a better understanding of the invention, its operating advantages and specific objects attained by its use, reference should be had to the accompanying drawing and descriptive matter in which there are illustrated and described preferred embodiments of the invention.

### SUMMARY OF THE INVENTION

The present invention is a medical identification wristband. The specific aim of the medical identification wristband is multi-fold. The goal of the new, electronic, MP4, Audio/Visual, Medical Identification Wristbands is to inform, alert, and empower end-users such as patients, physicians and other healthcare providers. The present invention will store an individual's personal demographics; medical conditions; emergency contact information; all medications, dosages and times taken; medical/dental insurance information; advance directives and special treatment requests; X-rays and recent lab results; allergies; physicians and pharmacy addresses and phone numbers; past medical history including any diseases, surgeries, immunizations; etc.; I.D. Photo; as well as an agenda to input medical appointments, notes and virtually any additional medical information.

The present invention, an I.D. Wristband is the style most accepted around the world. Medical personnel look for this particular wrist item in emergency situations and find it easy to use. It's a high-tech, luxurious, Medical I.D. Wristband, which also has the capabilities of playing songs/lyrics, movies, voice recordings, FM radio as well as displaying pictures and the time. It exhibits perfect sound quality, high reliability, a great appearance and should bring a user self-assurance in emergency medical situations as well as digital-era enjoyment.

The present invention can display, store, voice and transfer an individual's Personal Demographics, chronic Medical Conditions, all Medications, Emergency Contact information, Advance Directives, Medical/Dental Insurance data, Special Treatment requests, Allergies, Physicians and Pharmacy information, JPEG & DICOM X-Ray Images, Lab Results, ID Photo, Medical History including diseases, surgeries, immunizations, etc., as well as charts and graphs and has a Miscellaneous section to input medical appointments, notes and virtually any additional medical information a user deems appropriate.

The medical information noted above will be stored in a stylish, electronic wristband that can be instantly seen on its small, graphic, LCD view screen. This data would include an entire medical history as well as any special treatment requests like: process for resuscitation, organ donor, have living will requests, language other than English understood/spoken, have implant, and basically any other notes that may be important to that specific patient (i.e., charting & graphing, diet/exercise programs, Web favorites, etc); Empower patients to be more aware of their personal health; Facilitate the transfer of knowledge and information to first responders, paramedics, physicians, and hospitals; Enable the patient to receive all the special, personal, emergency care that is needed relative to their chronic illness or advance directives; and allow patients to get in and out of the hospital faster, safer, and less expensively as well as lessen the number of lawsuits for mistreatment, thereby reducing physician malpractice premiums and the expenses insurance companies payout.

During the last five years, personal health information has been discussed at the national level. Most recently the White House created an appointed position at the US Department of Health and Human Services for a national coordinator for health information technology signifying the importance and advancement of technology as it relates to healthcare. The aftermath of Hurricane Katrina has pushed this discussion to the forefront after hundreds of thousands of New Orleans residents were forced to evacuate without any records of their medical history. That unfortunate tragedy has forced policymakers at the national level to propose changes on how to effectively store medical records and personal health information. The implications of losing medical records are life-threatening, irreversible, costly, and time consuming.

These proposed Medical Identification Wristbands will serve the needs of over 68 million consumers in the US who have any of over 125 pre-existing, chronic medical conditions, which include diabetes, Alzheimer symptoms, allergies, transplant surgery procedures, mental conditions, coronary heart disease, epilepsy, asthma, HIV/AIDS, hepatitis, heart disease, cancer, etc. These electronic Medical Identification Wristbands will alert trained health care professionals that the person wearing the device has certain medical concerns that could require specialized treatment.

The technology industry is an evolving market, which experiences constant upgrades and updates. These Personal Medical Identification Wristbands will be manufactured to anticipate changes in software applications and devices in the next five to ten years. The software will be made compatible with other coding software currently implemented by most hospitals and health care facilities.

These Alerting Medical Identification Wristbands will revolutionize the advancement of the use and application of personal health systems. This proposed prototype seeks to meet the needs of individuals in the United States alone, in addition to those individuals who speak Chinese, Japanese, Spanish, French, Italian, Korean, Portuguese, German, and Thai as the Medical Identification Wristband supports those international languages as well and can thereby be sold worldwide.

One of the largest factors contributing to growth in medical technology is the rise in elderly populations around the world, particularly in the developed, industrialized nations. This electronic, medical I.D., wristband device is critical to individuals in the United States alone. These individuals with chronic medical conditions are plagued with unfortunate circumstances. Having a device that allows them to function with complete peace of mind in any medical emergency situation in their everyday lives provides immeasurable added value. The present invention will initially concentrate marketing and sales efforts on two main segments of consumers. The two markets are the adult/elderly market and the adolescent children's market with differences primarily in lifestyle, age, and marketing appeal. Both these markets will contain individuals who are currently suffering from chronic medical illness. Only a small percentage—approximately 4%—currently owns a MedicAlert® wristband, or similar bracelet or pendant from another competitor.

Until now there has been little attention paid to the adolescent market. Young adults are active and parents love to see them be happy and enjoy life as much as possible. Information about children's medical conditions should always be made available and updated, as needed. The present invention makes it easy to update their profiles and provide the best technological advances available in this area to better safeguard their welfare. It is felt that children will want to wear this computerized, high-tech wristband where they can show it working to their friends.

To encourage young people to utilize this important healthcare device, the present invention has incorporated added memory, up to 8 GB, in the storage chips in which to record MTV songs/lyrics and movies. In addition, a person is able to record their voice and to play their whole medical history back to first responders, EMT's or hospital personnel when needed. This “wow” factor can be bridged to the adult population as well where most will be grateful of the complete service and added value it provides.

The present invention targets children between the ages of 13 to 17, adults, and the elderly whose clinical problems experienced by this population include a majority of heart diseases, cancer, and respiratory diseases among others according to the Centers for Disease Control and Prevention (CDC).

Children and elderly living everyday with these illnesses are not immediately concerned with the safety of the medical procedures or with the medication administered to them if they were to be delivered into the emergency room. Over 68 million Americans have a medical condition, which should immediately be made known to emergency personnel or hospital staff Diabetes, Alzheimer symptoms, transplant surgery procedures, mental conditions, coronary heart disease, epilepsy, asthma, individuals that are HIV positive, individuals that have hepatitis, heart disease, cancer, etc. are all illnesses that need special attention. Medical identification wristbands are designed so that individuals get immediate attention, specific to their condition, with trained personnel.

Members of this target population will serve as end-users. These end-users will play an integral part of the design and improvement of the medical identification wristbands to better serve and meet their unique needs. The goals of the present invention include, but are not limited to: Improving the quality of life of the target population; Facilitating the transfer of knowledge and information; Designing a personal health care management system; and Reducing the quantity of adjusted years lost.

Accordingly, it is an object of the present invention to provide a cosmetically pleasing and more stylish wristband, which will be more appealing to the male population than existing MedicAlert bracelets. A feature of the present patent pending device, succinctly stated, is that it resembles a more fashionable, MEDICALERT type bracelet, which has an electronic LCD display that can transfer up to 0.3 MB of medical related data onto an ambulance lap top or hospital computer for quicker perusal.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a front view of a medical identification bracelet illustrating the display and one of a plurality of strap types and materials;

FIG. 2 is a front perspective view of a medical identification bracelet illustrating the display and control buttons and one of a plurality of strap types and materials;

FIG. 3 is a front perspective view of a medical identification bracelet illustrating the display and control buttons and one of a plurality of strap types and materials; and

FIG. 5 is a simulated display screen showing the Music screen of the present invention.

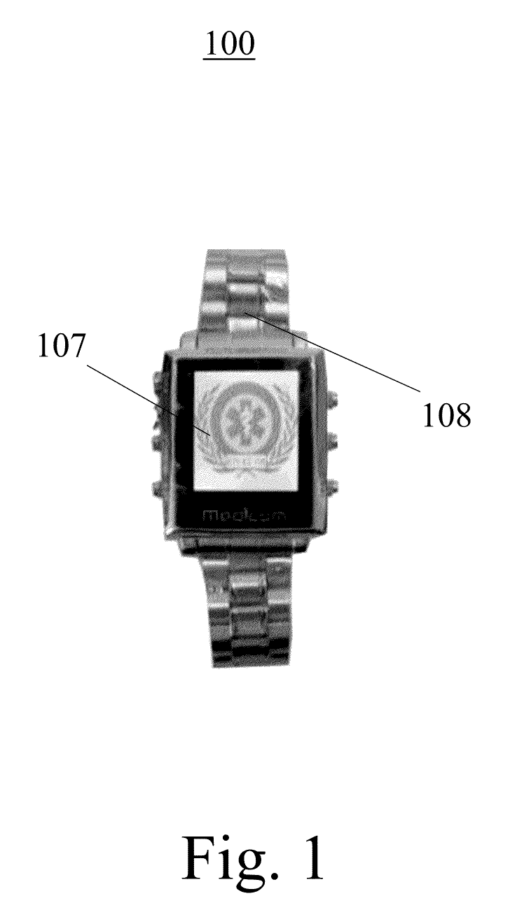

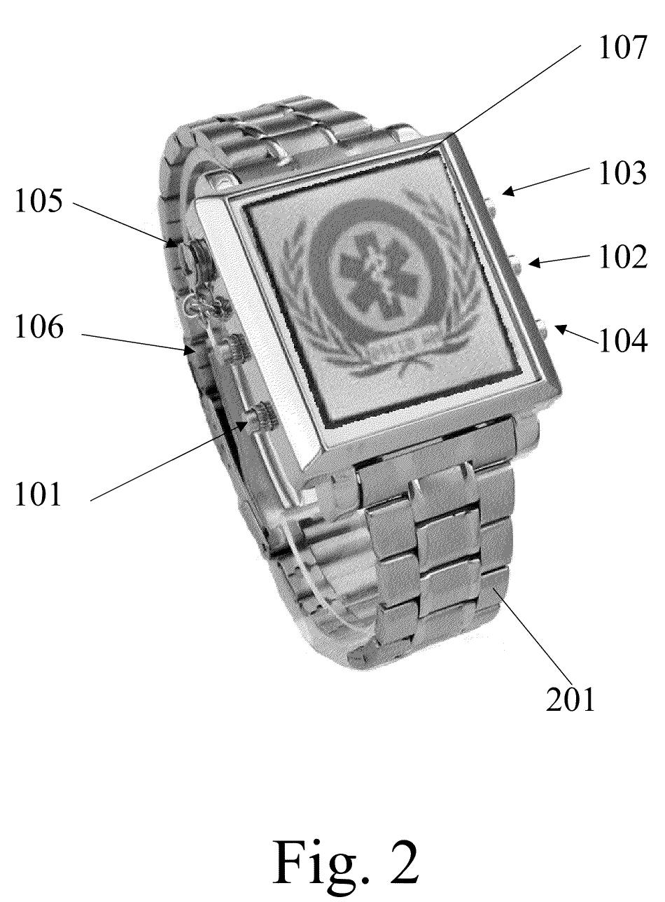

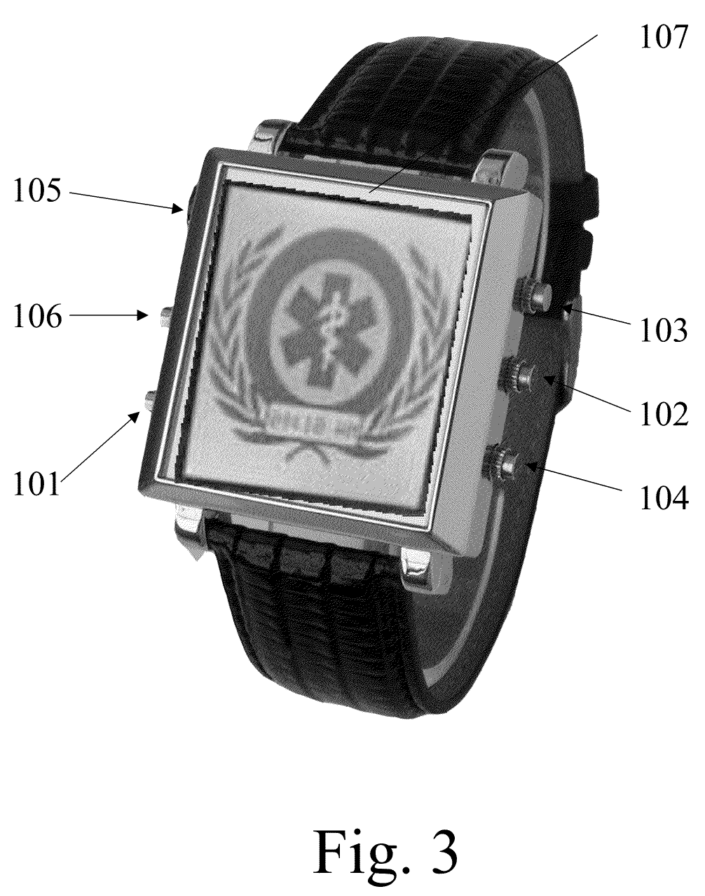

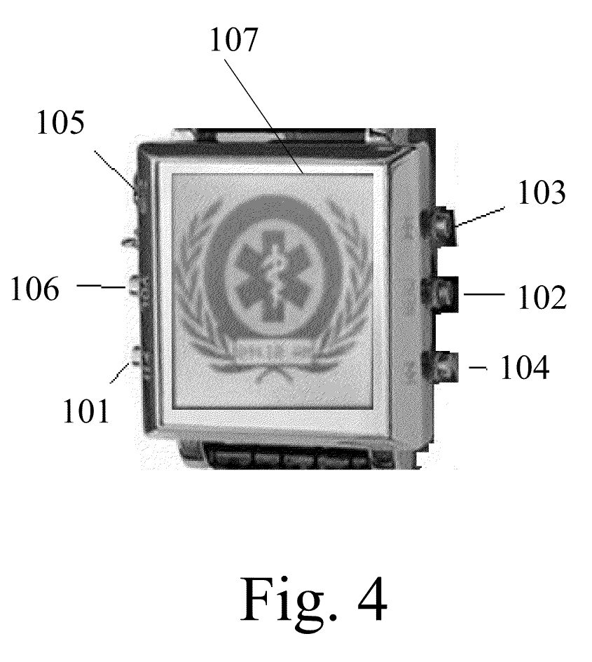

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Now referring to the Figures, the embodiment of the present invention is illustrated. The goal of the new, electronic, MP4, Audio/Visual, Medical Identification Wristbands 100 shown in the accompanying figures is to inform, alert, and empower end-users such as patients, physicians and other healthcare providers. This innovative healthcare device will store an individual's personal demographics; medical conditions; emergency contact information; all medications, dosages and times taken; medical/dental insurance information; advance directives and special treatment requests; X-rays and recent lab results; allergies; physicians and pharmacy addresses and phone numbers; past medical history including any diseases, surgeries, immunizations; etc.; I.D. Photo; as well as an agenda to input medical appointments, notes and virtually any additional medical information.

The specific aim of the Medical Identification Wristband 100 is multi-fold. This cutting-edge, computerized, the present invention seeks to: Store the medical information noted above in a stylish, electronic wristband that can be instantly seen on its small, graphic, LCD view screen 107. This data would include an entire medical history as well as any special treatment requests like: process for resuscitation, organ donor, have living will requests, language other than English understood/spoken, have implant, and basically any other notes that may be important to that specific patient (i.e., charting & graphing, diet/exercise programs, Web favorites, etc); Empower patients to be more aware of their personal health; Facilitate the transfer of knowledge and information to first responders, paramedics, physicians, and hospitals; Enable the patient to receive all the special, personal, emergency care that is needed relative to their chronic illness or advanced directives; and Allow patients to get in and out of the hospital faster, safer, and less expensively as well as lessen the number of lawsuits for mistreatment, thereby reducing physician malpractice premiums and the expenses insurance companies payout.

The Medical Identification Wristband 100 is a technologically advanced cutting-edge, inexpensive, personal medical device. One that empowers end-users through various innovative methods. This the present invention is a miniature, computerized, electronic, medical I.D. wristband that stores, displays and transfers personal health information such as medical history, prescriptions, special treatment requests and allergic reactions. This device is ideal for adolescents, adults, the elderly, disabled patients, and others who have chronic illnesses. These patients and their health care providers will have easy access to vital health information should there be any emergency or they are to forget their medical history, medications, and/or allergic reactions in any given day or during an emergency—even if the patient is in an unconscious state. The present invention can be readily updated electronically using a personal computer (PC) after each physician visit or if new prescriptions, lab results, etc. are issued.

This innovative, Personal eHealth application is a traditional, yet more stylish, medical identification wristband, which has electronic circuitry to display patient medical information. The wristband is set up using a personal computer into which can be entered between 2 GB to 8 GB of medical and personal information about an individual in a template form as well as entertainment data. The 2 GB to 8 GB is the overall storage capacity. Only about 3 MB is anticipated as needed for medical data text itself, the rest is for X-Ray, I.D. Photo, music and movie storage, etc. The personal computer formats and transfers the medical information to a wristband storage chip via a USB cable/port connection 105. The wristband has affixed an LCD view screen 107 that displays, in a scrolling fashion, eHealth data when a wristband button is pushed. The information may be scrolled and paused. All information is available on the wristband display screen 107 or can also be transferred to an ambulance laptop or hospital computer monitor via a standard USB 2.0 cable. The character size is selected to be visible to the unaided eye.

Three files cannot be seen on the Wristband 100 screen 107 since they are too large (˜50 MB). They include the Jpeg/Dicom X-RAY, ADVANCE DIRECTIVES, and MED/LAB REPORTS Files. These particular Files can be saved in the Wristband 100 and uploaded to any ambulance/hospital computers via the included 2.0 USB Cable.

This the present invention went contrary to the teaching of the art because the information will now be available without an auxiliary device for reading the information such as that which would be needed to read a card or a chip implanted within the human body. It has filled a need for detailed information about an accident victim available right at the accident scene. The first person arriving in an emergency situation or making the initial phone call to a hospital or EMT service will be able with this special wristband to provide critical and detailed medical information about that victim immediately without the hospital having to call a 1-800 number just to get a few lines of thought provoking data.

The hospital or EMT crew can now be in an optimal position to better prepare their emergency room, operating room, or ambulance with any special supplies, equipment, or medications which may be required to deliver the best possible aid in the shortest possible time. An Alzheimer's patient can have a first responder make a call to the contact person noted on the wristband view screen 107 instead of requesting emergency services if none are really needed.

The present invention comes equipped with a special AMV filming function. A user can view images in JPEG format. The device has a unique outer appearance that separates it from other products. It has an outside stereo speaker design but A user can wear earphones to hear the voice recordings or music. The device supports various audio formats such as: MP1, MP2, MP3, WMA, WMV, ASF, WAV etc. It is designed to view, voice and upload 14 separate, personal, medical-related files to assist first responders and hospital personnel in emergency medical treatment situations. The firmware upgrading function enables A user to download updates from the web. The FM Stereo radio presents strong auto scanning and presetting functions that allow A user to save up to 20 of their favorite FM channels. Also, with the help of the included internal recording function A user can record the medical information and favorite programs into files. There is no need to install the enclosed driver in a WIN2000 system or above. Just go to “My Computer” and access the USB disk function to work on the documents. As simple as plug and play. The USB mode is entered by connecting the wristband to a computer.

A user can divide the magnetic disc into two parts utilizing the attached tool to keep one side encrypted, hiding the files from being read/written by others, or open. A user can store Voice (Pronunciation) files with WAV and ACT format by recording through the internal microphone. Virtually any Medical File can be recorded and voiced so that emergency responders can not only see but hear the medical data. A user can enjoy the benefit of 7 kinds of sound equalizers viz. Nature, Rock, Pop, Classical, Soft, Jazz and DBB.

The Medical Identification Wristband 100 is incorporated with the features of multi playing Files in Normal mode, repeat One, Folder, repeat Folder, repeat All, Random and Intro.

The present invention includes one of two initial models of wristband. One model has a strap and screen holder 108 made of a silicone, rubber-like compound in black. The second model has a strap and screen holder 108 that is of stainless steel 201. Accompanying the chosen wristband will be a USB 2.0 cable, set of earphones, AC/DC charger, an instruction manual, a Med Alert wallet card and software/driver disk. The customer will use the secure, software program disk included with each order to input their detailed, medical information on their PC or Lap top for the first time and for any subsequent revisions to their medical conditions, medicine, insurance, advanced directives, processes for emergency treatment, etc. Not only will individuals be able to input and update their own data via their own personal password; but also, family physicians in their offices or nurses at hospitals will also be able to update and/or input initial and additional information for the patient via the Internet, which can then be downloaded/uploaded to/from the wristband/bracelet/pendant microchip via any PC so that all the data is correct and can be changed whenever needed and from anywhere in the world where a

PC or laptop can be found.

The presenting invention supports MP3, WMA and MP4 (MTV) video formats. The presenting invention has a 1.5″ (OD) TFT screen 107 100 that presents clear text and high-resolution pictures and 128 MB-4 GB inner flash memory. The presenting invention can also display time and date utilizing OLED technology and supports TXT format E-Book function. A general E-book function of the wristband of the present invention has the capacity to store medical EMT-FILES. The presenting invention supports JPEG & BMP picture format and X-Ray, DICOM format downloading/uploading capability as well as digital, voice recording, song circulation and language selection functions. The presenting invention is equipped with 5-equalizers with super bass and 3-D sound effect playing mode.

Now referring to FIG. 4, the present invention is navigated by button control through a series of display windows. There are four operations buttons that combine a number of functions each along with a USB/charging port 105. Button Functions include: a Play button 101 enabling Turn On/Off, Play, Stop; a Menu (Mode) button 102 enabling Choose, Enter, Enter Subdirectory; a Next+ button 103 enabling Next section, Scroll forward and Sound volume increase; a Previous− button 104 enabling Last section, Scroll backward and Sound volume decrease.

A Function Screen enables a user to select one of a plurality of functions such as Music, Video, Photo, Voice, Medical EMT Files, and Settings. This present invention supports Windows/Linux/Mac, etc. system. If a user looks at the wristband with the name MEDICOM or other trademark on the bottom, a user will see three buttons 103, 102, and 104 on the right and two buttons 101 and 106 on the left with a USB/power port 105 on the upper left. The top button 103 on the right is the Next/+ key. The middle right button 102 is the Menu/Enter key. The bottom right button 104 is the Previous/− key. The bottom left button 101 is the Play/On key. The middle left button 106 is the Volume key used in conjunction with the +/− keys to increase or decrease volume.

There are four types of Key Pressing actions: short press, long press, continuous press, and separate press. Usually all key pressing is done in a short press type of action unless specifically instructed otherwise. Short Press: Press the key quickly and the desired effect happens at once. Long Press: Press the key for over 1.2 seconds to obtain the desired one effect. Separate Press: Press the key and the selected effect happens when a user release the finger from the key. Continuous Press: Continuously pressing the key until releasing the finger will cause the selected action to keep repeating, such as “Skip Forward” and “Skip Backward.”

Key Functions include: “Play” key: Power On/Play/Stop; “MENU”/(MODE) key: Choose, Enter; “Vol” key: Used in conjunction with “Next” key to increase volume or “Pre” key to decrease volume; “Next” key: Next item, Skip Forward, Increase; “Pre” key: Previous item, Skip Backward, Decrease; and “USB” A Standard hole 105 to insert earphone or USB 2.0 cable to listen to music, movies, recorded voice or transfer data or to recharge is provided.

All the screen 107s must be manually advanced forward or backward. There is no automatic free run of screen 107s as originally stated to allow better user operation. There is also a file called a PHOTO I.D where one can put in his/her face photo that can be used for I.D. purposes.

All A user must do is press the Play/On key 401 for two seconds and the Wristband 100 turns on with a display of the EMT, International Star of Life Symbol. Press the Menu key 102 and a user can pick from any of seven modes. Use the +/− keys 103 and 104 to go next/previous selections on the Menu and press the Menu key 102 again to select the EMT-FILES Folder. Play that Folder to get a listing of the Files and select the one of interest by pressing the Menu key 102.

A user can enter into the main menu by stopping what they're playing and (long) pressing the Menu key 102 for a few seconds. To reach the subsequent sub-menu while in a playing or stopped mode, quick (short) press the key.

The browsing option enables a user to: Browse and select the song of their choice for instance from the ones they've listed in the menu item. The browsing option also helps a user to skip backwards and forwards while playing a song.

A user must enter the main menu by a long press on the Menu key 102. A user can then enter any of several different functional modes once there.

A user can reduce the volume by pressing the Vol key 106 then press the Pre key 104. Similarly, a user can increase the volume by pressing the Vol key 106 then the Next key 103. To turn the Wristband 100 on or in case of a power off, long press the Play key 101. To turn the Wristband 100 off when it is turned on, long press the Play key 101.

To play or stop music and exit from sub menu, user must short press the Play key 101 for playing music while in the MUSIC playing mode. Short press the Play key 101 for stopping music while in the MUSIC playing mode. In record mode, short press the Play key 101 to pause the recording, long press to stop recording.

For clock display a user must turn on the Medical ID Wristband 100 by long pressing the Play key 101. Then press the Menu key 102 and select the Settings mode. Then press LCD set—Clock display. Initiation of the time adjustments is made by pressing the Vol key 106. Next or Pre key 104s add or decrease value. Pressing the Menu key 102 saves the selection and exits the operation.

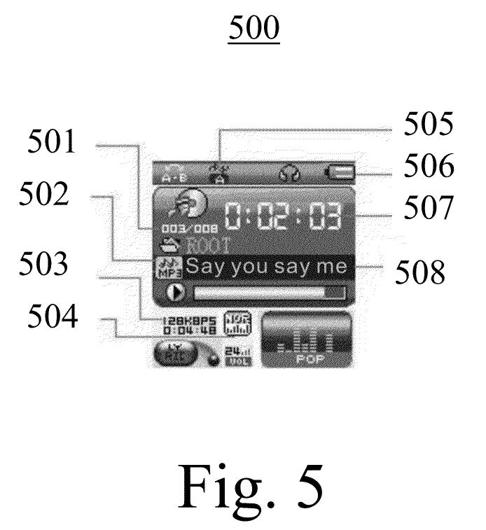

The music player 500 provides easy operation as shown in FIG. 5. The music player shows the music number 501, the file format 502, bit rate 503, Equalizer mode 504, a repeat mode 505, the power display 506, play time 507, and the music title 508.

First a user must insert the earphone into the USB hole 105. Next, a long press of the Menu key 102 to enter the “MUSIC” mode, and then short press the Play key 101 to begin playing the selected song from the play list. Then choose music: Pre key 104: Choose previous music on the play list. Use the Next key 103 to choose next song on the list. Press the Vol key 106 then the Pre key 104 to reduce the volume. Press the Vol key 106 then the Next key 103 to increase the volume.

For the musical effectiveness mode, a user must first select the MUSIC mode from the main menu to enter the music control screen 107. Then short press the Menu key 102 to enter the Broadcasting sub menu. Then press the Next key 103 to choose the “Equalizer” menu item. Short press the Menu key 102 to enter the selective submenu of the “Equalizer” mode. Choose one of the Musical Effectiveness mode selections. Finally, press the Next key 103 to choose then short press on the Menu key 102 for the effect.

The Wristband 100 supports *.LRC lyrics files such as those downloaded from a website. The lyrics can be arranged in the desired manner and can be displayed while playing the related song. A user should always save the lyric file having the same name as that of the related music file. For example: Name of song file is: Say you say me.mp3 Name of lyric file is: Say you say me.lrc. Long press on the Menu key 102 to enter the Lyrics interface. Lyrics are then presented. Short press on the Menu key 102 to return to the song mode.

While broadcasting AMV movies, only the following keys are effective: Play key 101: Used to play, stop playing or a long press to power-off; Menu key 102: Long press to enter the main menu; and Pre/Next key 103s: Move to a previous movie/next movie added to the play list.

For Video, a user must first insert the USB CD to install the MP3set4_{—}13 tool. This tool is used for transforming media files of various formats into the AMV format, which can be played on the MP3/MP4 Player. Click the “Input File” button and select a movie that needs to be converted to AMV and follow the subsequent prompts. (WMV files as an example.). Click an “Output File” button and select the target where a user want the converted files to be saved then click “OK.” Press the Play arrow to change the file status from “Unconvert” to “Success” for those files whose boxes a user keep checked. (Make sure that file can play normally at first before carrying carry on the conversion). The AMV file parameters can be set for the selected movie or fragments including the interception video fragment, video width and height, picture format and image quality, etc., by selecting and filling in the required information. Time is set in hours, minutes, and seconds. When a fragment is chosen, the selected points will be indicated: S(Start) time, E(End) time, R(Fragment) time, and T(Total time). For video resolution of all AMV files, please choose 160×120 pixels as well as the default settings for video convert (Normal) and image quality (High). If a user has no visual images they should check the box that says “Insert picture for no picture” for a better effect.

To substitute the old audio file with the new audio file (WAV type) by opening a new audio part file path, then press the OK button. For better effect, check the “Insert wave for not enough wave” box. Check the “Overwrite file” to replace the current file by the new converted AMV file. “Play after converting” means the AMV Player will begin to play AMV files automatically after conversion. While playing the file, right click on the image; choose Property to check the video width and height and frames per second, etc.

The present invention has the function of downloading media files from the Internet, viz. after searching out the media files, right click on the file link, choose “Add to AMV convert tool,” then choose “yes” in the dialog box that opens and click OK. Check the desired files and click “Download.” Normal downloading will display the downloading process and the status will show “Success” after downloading. If it cannot be downloaded the status will show “Failed.” Finish downloading, click the “OK” button then click the “OK” button in the dialog box to close it. After downloading the media files, the tool will run automatically and add the media files, which were downloaded to the convert list. The files will be saved in the install path, through the “File Name” column. A user can check the conserve path of the file, e.g. D:\Program Files\MP3 Player Utilities 4.13\AMVConverter\data. The convert methods are the same as the previous section.

If a user want to convert Real player, QuickTime or MPEG2 files, they should first install the corresponding decoder. When a small size AMV file is converted to a big size AMV file and the setting of “Picture Transform” is Normal, it will not convert. If a user select a different OPTION it will go through the conversion but it will reserve the small size and frames per second of the source AMV file. There is no limit to a big size AMV being converted to a small size AMV file. To play SWF (Flash) format files, the tool will use the IE browser. This tool doesn't support the audio and video character display of the AMV file that is converted from Flash (SWF file). The tool also does not support the “Intercept video fragment” function of an SWF file.

This MP4 Medical ID Wristband 100 supports 99 recording files under each directory. A user does not need to connect a microphone to make recordings. Record in RECORD mode. First, Enter the main MENU; Press the Next key 103 to choose RECORD mode; Shortly press the Menu key 102 to enter the Recording mode then select Recording Type.

Choose the suitable recording type by short pressing on the Next key 103 and then short press the Menu key 102 to enter the chosen type as shown in Table 1.

TABLE 1
Recording Types

| | |
|---|---|
| Fine REC, High-quality | WAV type, good sound quality. |
| recording | |
| Long REC, Long-time | ACT type, average sound quality. |
| recording | |
| Fine VOR, High-quality voice | WAV type, (Voice-controlled recording. |
| control | Recording will pause if no voice heard.) |
| Long VOR, Long-time voice | ACT type, (Voice-controlled recording. |
| control | Recording will pause if no voice heard.) |

Shortly press the Play key 101 to start recording.

The recorded sound is saved onto the current directory set in the stopped, main directory “Record” sub menu. If the screen 107 ever presents “Full Space,” it means there is no space left in any of the directories to record new files. Please delete other files in a directory to free up some space. If a user see “Directory Full” on the screen 107, it means this directory already has 99 recording files entered. Please change to another directory or delete some space in the present directory. The recording process only responds to the Play key 101.

To play the Recorded File Enter the main MENU; Press the Next key 103 to choose the VOICE mode; Press the Menu key 102 to enter the Broadcasting interface; select the file and press Menu then Press the Play key 101 to start playing. To choose the recorded file: Pre key 104 chooses a former recorded file while the Next key 103 chooses the next recorded file.

Volume control is enabled by pressing the Vol key 106, then short press the Pre key 104 to reduce the volume. Press the Vol key 106, then short press the Next key 103 to increase the volume.

Files recorded in “ACT format” can be converted to “WAV format” through the installation procedure in the tool package attached with this Medical ID Wristband 100. To operate the “Sound Converter” procedure; click the “Open” key. Choose ACT file. Click the “Convert” key to start converting into a WAV file. In addition to playing files converted from an ACT to a WAV format, this tool can also play files in an MP3 format.

Each time a user enters the FM RADIO function, it will automatically turn to the broadcasting mode. Return to the current preset radio stations, which always begin with the lowest frequency station listed first. Changes of present frequency are recorded dynamically. Twenty radio stations are the most that can be preset.

To listen to the FM radio: Enter main MENU; Press the Next key 103 and choose FM RADIO mode; Short press the Menu key 102 to enter the FM RADIO mode; An “Automatic Search” will be conducted: Press Pre/Next key 103 for 2 seconds, the Medical ID Wristband 100 searches radio stations forward or backward by 100 KHz, then stops on the frequency of a selected station. If a user want to stop searching, press Pre/Next to stop. For fine tuning: Press the Pre key 104: Searches Backward by 100 KHz; Press the Next key 103: Searches Forward by 100 KHz. To save certain frequencies: Short press the Menu key 102 to the FM RADIO sub menu and choose SAVE. Repressing the Menu key 102 will save the station. If there are more than one preset radio stations, a user can shortly press the Next key 103 to advance from the lowest frequency on up and then the Play key 101 to receive the selected radio station.

While receiving the selected radio station, a user can record the favorite high-quality songs/programs. Short press the Menu key 102 to enter the FM RADIO sub menu. Choose recording or long-time recording action, then a user can record the current broadcasting song/program into a recording file. Long press on the Menu key 102 to exit from the recording.

JPEG picture browsing requires common JPEG formatting supported from the website a user may be viewing or with that of the pictures in the Photo/Picture Folder.

When a user enter the main Menu, a user will notice a file selection list from where a user select the desired file. The directory will appear empty if there is no file loaded in it. A user must press the Play key 101 to enter into the Picture Viewing mode. Press the Pre/Next key 103 to choose the previous/next file. Press the Menu key 102 to enter into the stop sub menu where a user will see: Directory selection; Playing setting; File deletion; Exit. Playing conditions are: Manual playing and Automatic playing. Paging up & down can be set from 1˜8 seconds under automatic playing mode. Other keys have no function.

To enter picture viewing mode, a short press the Next/Pre key 104 to show present/next/previous picture. Short press the Play key 101 to return to the file selection mode. Long press the Menu key 102 to return to the main menu. Other keys have no function.

For EMT-FILE selection a user enters the main MENU, they press the Next key 103 and select EMT-FILES. User's choose the Wristband 100 Screen Data file by short pressing the Play key 101. Short press the Next key 103 or Pre key 104 to select the next/previous desired TXT files. Enter the asked for alphanumeric information into the emergency EMT-FILES. Short press on the Play key 101 to exit the TXT files. Long press the Menu key 102 to go back to the main menu.

For entering Information in the EMT-FILES some files (ex., Advance Directives, Lab/Med Reports, I.D. Photo and X-Rays) require a user to right click and copy the documents then right click and paste the copied documents into the appropriate program Files in the Folders or to select the appropriate command from the USB setup Window to download an X-Ray disc or Photo for example that has first been saved into a folder on their PC. A user can then transfer the completed Files to the Wristband 100 by inserting the USB 2.0 cable into the Medic ID Wristband 100 and the computer and pressing save in the file tab. Follow the Window Instructions that appear.

To copy, paste or upload Files to another computer (ex., ambulance/hospital) all that is required is the USB 2.0 cable that serves as the USB connection between the Wristband 100 and the computer. Connect the Wristband 100 and computer via the USB 2.0 cable. An operations Window Mark will appear on the computer screen 107. Go to the desired document file, photo or JPEG disc, Right Click and copy it or Click the folders on the 7^{th} line or a user can open the computer Windows Marked on the screen 107 where a user will then see the MED ALERT DATA Folder (Removable Disk (H)). Click on the MED ALERT DATA Folder. A user will then notice 14, EMT-FILES as seen on the MP4 Wristband 100 screen 107 including: Demographics, Medical Conditions, Medications taken, Allergies, Insurance, Emergency Contact, Special Requests, Physicians/Pharmacy, Medical History, I.D. Photo, Miscellaneous, as well as Advance Directives, Lab/Med Report Files, and X-Rays containing JPEG or DICOM disc X-Rays that have been committed to the MP4 Wristband 100 memory chip for uploading, To be seen on the monitor screen 107 (uploaded), just click on the desired file to view.

When typing information into selected text Files, no more than 20 alphanumeric letters/numbers/symbols can be placed in each row, including the spaces between words. For example, Name: John Smith Jones (22 letters/symbols/spaces). Address: 2849 Kalanianaole Ave., Phoenix Ariz. 12345 (49 letters/numbers/symbols/spaces). Typed in the Template and subsequently transferred to the MP4 Medical ID Wristband 100 will look like:

Name: John Smith Jones

Address: 2849 Kalani

anaole Ave., Phoenix

Ariz. 12345

For system set up and entering data, System Parameters as shown in Table 2 are established. Each item may change subject to any future, firmware upgrade. First a user must Enter the mainMenu then press the Next key 103 for “SETUP” selection. Finally, a short press of the Menu key 102 to enter into the “System Set Up” functions.

TABLE 2
Parameter Items

| | |
|---|---|
| System Time | Sets the date and time. |
| LCD set | Sets screen 107 brightness, darkness or black screen |
| | 107 mode. |
| Language selection | Sets different country languages. |
| Power-off setting | Sets the countdown time (minutes) to power-off. |
| Replay setting | Sets desired working conditions for replaying. |
| On-line setting | Selects the “extreme degree space” regarding |
| | function operation |
| Memory info | Checks memory size and use conditions. |
| Firmware upgrade | Special tool for firmware upgrading. |

For “System Time” setting a user first must go to SETUP and select the System Time interface; shortly press the Menu key 102 to enter the “System Time” interface. For System Time, short press the Vol key 106 to start the year/month/day setting. Year will blink. Press the Next key 103 to add valve (Pre key 104 to reverse). Press the Menu key 102 to exit when the setting is complete.

Brightness Adjustment adjusts brightness of the LCD. 15 is the brightest and 0 is the darkest. Press the Next/Pre key 104 to move the selection cursor. Press the Menu key 102 back to the previous menu. Black screen 107 mode (0-15) sets the time duration and changes the screen 107 black if no key is pressed. “Dark” mode and “Black Screen” mode refers to the “Brightness Adjustment.

A “Power Saving” mode is taught by the present invention. While functions are stopped, setting a time (unit: seconds) here will show how long will pass before the Wristband 100 shuts down to save power. If no key is pressed, the number 0 shows this function is terminated. In a “Sleeping” mode, a user can set the sleeping time (unit: minutes) only once and when there is no power, the set time is cleared so that the next time a user want to set the sleeping time, re-setting is necessary.

The Medical ID Wristband 100 functions by means of a standard USB disc. Support for a Windows98 system requires the installation of a driver. Systems such as WINDOWS 2K, MAC OS 10.3 and LINUX REDHAT 8.0 or above require no driver.

The Wristband 100 of the present invention can draw power through the USB cable and play without using the battery when connected to a power source. Under the “Standby” mode, short press on the Menu key 102, exit to main Menu, then select “Service” mode again. This device supports a “Suspend” mode.

Connecting to a computer, the Wristband 100 (MP4 shown) can display three modes: Standby mode, Downloading mode, and Uploading mode. Firmware on the device can be maintained or upgraded through tool software in the included disc and installed in a computer. Enter main MENU. Press the Next key 103 to select SETUP. Short press on the Menu key 102 to enter “System Setting” or “System Set Up.” Press the Next key 103 to select “Firmware Upgrading” then short press the Menu key 102 to enter it. Now connect the Medical ID Wristband 100 to the PC via the USB 2.0 cable. “MP3 Player Update:” Operate the upgrading tool “MP3 Player Update” on the PC then click the button to select the “New Version File.” Select the “New Firmware” procedure that can be found on the included disc. Click the “Start Upgrade” button for the processes to begin upgrading. Once the upgrading is finished, the Wristband 100 shows: “Upgrading firmware is done to improve and optimize the function of the Wristband 100. Normal operation of play itself, however, will not be affected by not upgrading the model.” Firmware upgrading may in fact cause a malfunction of normal operation to the Medical ID Wristband 100 due to wrong subsequent operation.

A user can put different files into different directories for better document management. Directories are to be created in a computer first. This device supports nine main directories. Individual directories can be set according to Music mode, Record mode or Voice Broadcasting mode. Consequently, those three modes aren't necessarily required to have the same directories.

Under the Music mode, Voice Playing mode and FM Radio mode, files and saved radio stations can be deleted. Short press the Menu key 102 to enter the stopped sub menu. Press the Next or Pre key 104 to choose “Delete file” from the menu. Press Menu key 102 to enter Deleting. Choose the song to be deleted by a short press on the Menu key 102 to enter interface. Press the Next or Pre key 104 to select “Yes” from the menu then short press on the Menu key 102 to confirm.

“Delete All” will delete all documents in the selected mode within the present directory. (e.g., Full deletion in the Music mode only deletes all musical files but will not delete any Recording files.) In FM mode a user only need to go to step #3. The radio stations a user picks to delete are from those saved stations a user have already preset.

A user can choose different playing modes (Repeat, Shuffle, and Intro.) when playing Music and Recording files. “Playing mode” is listed as the first item in the Playing sub menu. Once selected, playing will go as specified in Table 3.

TABLE 3
Different playing modes
(REPEAT)

| | |
|---|---|
| [symbol] (Normal) | Songs in the current directory finish then |
| | music continuously plays in the next |
| | directory until all files complete and then it |
| | stops. |
| [symbol] (Repeat One) | Repeats playing a single file. |
| [symbol] (Folder) | Plays all music in one directory (folder). |
| [symbol] (Repeat Folder) | Repeats all files in one directory (folder). |
| [symbol] (Repeat All) | Repeats playing all music. |

(SHUFFLE)

| | |
|---|---|
| [symbol] (Random) | Plays music in the current folder randomly. |

(INTRO)

| | |
|---|---|
| [symbol] (Intro) | Plays the first 10 seconds of all music in the |
| | current folder in sequence. |

For Music playing: Short press the Menu key 102 to enter the Playing sub-menu in MUSIC. Press the Next key 103 to select the “playing speed” item. Short press the Menu key 102 to enter the “playing speed” selection menu. Press the Next key 103 to speed up and the Pre key 104 to slow down the speed. Changing the speed will have an effect on all subsequent songs until it is reset again.

For VOICE playing or MUSIC playing: Short press the Menu key 102 to enter the related Playing sub-menu. Press the Next key 103 to select the “Repeat” mode menu. Short press on the Menu key 102 to enter into the “Repeat” mode.

For Voice/Reading Function (This is not the actual voice playing function.), short press the Next key 103 to enter the Voice/Reading mode. Shortly press the Next key 103 to enter the speaking (reading) mode. Repeat sign “A-B” changes to the Read sign. From this point, start to record the user's voice. Time length is the same as the A-B repeat time. When time is up and a user want to replay the original sound, the sign changes. Now a user needs to perform the Contrast function by pressing the Next key 103. Press the Pre key 104 to return to “A-B Repeat” mode.

Once a user enters the Contrast function, the Repeat sign displays. Now a user can begin to play the original sounds. Original sounds can be played over but when the sign changes the user's voice can be played. Under these conditions, press the Pre key 104 to return to “Voice/Read follow” function. Under the above mentioned three modes, short pressing on a mode will Exit the “Repeat” function.

Generally, MP3/4 users do not like to “divulge information.” They do not want their “personal data” to be seen by others when their friends borrow their MP4 for example.

Users may use the attached tool included with this Medical ID Wristband 100 to separate the USB disk into two parts. Users can then see two icons of the disc displayed on their computer.

WINDOWS 2K users need to install SP4 as well; otherwise, there will only be one disc seen. To see the discs, choose “single ordinary disc” or “signal encrypted disk” in the “System Setup/On-line” mode. If a user select to encrypt one of them (without encrypting, two disks are available for use) the contents will be hidden and no person can see the data without using a valid password. Connect the Medical ID Wristband 100 to the computer and insert the USB disc. Operate the installation procedure tool included. The format window tool will first appear on the screen 107. Select “Zone and Encryption.” Decide a suitable volume for the disc to be encrypted and enter it. Select the user's name and password (code) and put the password into the “New Password” box. Input the same password again in the “New Password Confirmation” box. Click the “Start” key to divide the disc zone. Once the disc has finished dividing, a new window message will appear as follows: The computer restarts after pressing “confirmation.” Confirm and restart the computer. A user can see two disks on the Window log. (For editions older than WINDOWS2K SP4 only one disc plate will be seen). Inputting the correct user name and password in the dialog mode box will allow a user to open and copy the “RdiskDecrypt.exe” executable file. In order to open an encrypted disc for viewing while connected to the computer, one must always input their user name and password.

The physical components of the present invention include a 1.44 CSTN screen 107, a high speed, USB 2.0 port, 2 GB-8 GB memory, a power source, sound recording means, a radio, audio output speakers and jacks, and an operating system.

The power source is represented on the display by a battery icon 506, which will appear once the battery is fully charged. The indicator 506 keeps updating the icon with an accurate battery level as the device is being used. When power is being used, the icon 506 begins to turn blank, which means the battery must now be recharged. It is a user's responsibility to make sure the Medical ID Wristband 100 always has enough power to operate. To stop charging, a user must unplug the USB cable from the Medical ID Wristband 100 then either disconnect the charger from the power source or remove the USB cable from the computer. A user should turn the power off when not using the Medical ID Wristband 100.

In an alternative embodiment the device of the present invention may be incorporated into a pendant work around the next or any other wearable jewelry.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A medical identification device comprising:
an LCD display screen 107 that displays, in a scrolling fashion, data when a button is pushed;
four operation buttons for navigation control through a series of display windows shown in the LCD display screen 107;
a Play button enabling Turn on/off, Enter, Play, Pause, Stop;
a Menu button enabling Return, Exit, Enter Subdirectory;
a Forward/Volume button enabling Next section, Scrolling forward, Delete and Sound volume decrease;
a Backward/Volume+button enabling Last section, Scrolling backward and Sound volume increase;
an operating system;
a function screen 107 shown on the LCD display enabling a user to select one of a plurality of functions such as Music, Video, Photo, Voice, Medical EMT Files, and Settings;
a high speed data port for connected to a computer providing means for transferring detailed medical information to said memory;
a memory storing an individual's personal demographics; medical conditions; emergency contact information; all medications, dosages and times taken; medical/dental insurance information; advance directives and special treatment requests; X-rays and recent lab results; allergies; physicians and pharmacy addresses and phone numbers; past medical history including any diseases, surgeries, immunizations; I.D. Photo;
the memory providing an agenda to input miscellaneous medical appointments, notes, and additional information;
a power source;
internal microphone providing sound recording means;
an external speaker;
an FM stereo radio with auto scanning and presetting functions that allow a user to save a plurality of channels.;
audio output speakers;
audio output jacks;
a strap securing said display screen 107 and other physical device components;
a USB/charging port; and
the display showing detailed medical information stored in the memory.

2. The device of claim 1, wherein the strap is constructed from stainless steel.

3. The device of claim 1, wherein the strap is constructed from silicone.

4. The device of claim 1, wherein the memory stores an entire medical history as well as any special treatment requests like: process for resuscitation, organ donor, have living will requests, language other than English understood/spoken, and implant information.

5. The device of claim 1, wherein the data port provides means for updating the information stored on the memory using a computer after each physician visit or if new prescriptions, lab results are issued.

6. The device of claim 5, wherein the computer formats and transfers the medical information to a wristband storage chip via the USB cable/port connection.

7. The device of claim 1, wherein all information is available on the wristband display screen 107 or can also be transferred to an ambulance laptop or hospital computer monitor via a standard USB cable.

8. The device of claim 1, further comprising
an AMV filming function wherein a user can view images in JPEG format.

9. The device of claim 1, further comprising
firmware upgrading function enabling the download of updates from the Internet via the USB cable/port connection.

10. The device of claim 1, further comprising
dividing the memory into two parts;
keeping one side of the memory encrypted, hiding files from being read/written by others, or open; and
storing Voice (Pronunciation) files with WAV and ACT format by recording through the internal microphone.

11. The device of claim 10, further comprising playing files in a normal mode, a repeat once mode, a play folder mode, a repeat folder mode, a repeat all mode, a random play mode, and an introduction play mode.

12. The device of claim 10, further comprising
a software disk providing means for inputting drivers and detailed, medical information on a computer for the first time and for any subsequent revisions to the medical information, conditions, medicine, insurance, advanced directives, and processes for emergency treatment; and
using the software on the computer for transferring medical information to the device memory.

13. The device of claim 10, further comprising
inputting and updating data via a personal password;
family physicians in their offices or nurses at hospitals updating and/or providing initial and additional information for the patient via the Internet, which can then be downloaded and uploaded to the memory on the device so that all the data is correct and can be changed whenever needed from anywhere in the world where a PC or laptop can be found.

14. The device of claim 1, further comprising
displaying time and date utilizing OLED technology; and
supporting TXT format E-Books;

15. The device of claim 1, further comprising
a PHOTO I.D where a user can put in his/her face photo that can be used for I.D. purposes.

16. The device of claim 1, further comprising
a plurality of sound equalizers with super bass and 3-D sound effect playing mode;
supporting *.LRC lyrics files such as those downloaded from a website; and
displaying the lyric files while playing the related song.

17. The device of claim 1, further comprising
an EMT, MED-ALERT DATA Folder in the memory;
the EMT, MED-ALERT DATA Folder containing: demographics, medical conditions, medications taken, allergies, insurance, emergency contact, special requests, physician and pharmacy information, medical history, and I.D. Photo as well as medical-related and laboratory reports, advance directives, and x-rays containing JPEG or DICOM disc X-Rays that have been committed to the MP4 Wristband 100 memory chip for uploading;
